(19) United States
(12) Patent Application Publication
(10) Pub. No.: US 2004/0008157 A1
(43) Pub. Date: Jan. 15, 2004

(54) Cap-mounted monocular video/audio display

(76) Inventors: Curtis M. Brubaker, Los Angeles, CA (US); Harry B. Wykes, Manhattan Beach, CA (US)

Correspondence Address: Edward Gray, P.O. Box 66629, Mar Vista, CA, 90066-0629, US

(21) Appl. No.: 10/607,181

(22) Filed: Jun. 26, 2003

Related U.S. Application Data
(60) Provisional application No. 60/391,772, filed on Jun. 26, 2002.

(51) Int. Cl. G09G 5/00

(52) U.S. Cl. 345/8

(57) ABSTRACT

A monocular video/audio display system which is easily attachable to and detachable from a baseball cap visor or hat brim by means of a spring clip attached to the upper portion of a casing. An arm pivotally attached to the casing lower portion is attached to an optics assembly having a housing containing a display and backlight assembly. The optics assembly also includes a focus mechanism assembly and an eyecup. The housing is attached to a gimbal which is pivotable about the arm. The arm and gimbal pivot parallel to a reference plane determined by the interface between the casing upper and lower portions. The casing houses a circuit board including wireless receiver circuitry and a fractal antenna.

### CROSS-REFERENCE TO RELATED APPLICATION

This application claims benefit of priority of provisional patent application Ser. No. 60/391,772, filed on Jun. 26, 2002 and entitled “Cap-Mounted Monocular Audio/Video Display.” Application 60/391,772 is incorporated herein in its entirety by this reference.

### BACKGROUND OF THE INVENTION

1. Field Of The Invention

This invention relates to portable video/audio display systems and, in particular, to a lightweight, portable video/audio display system that provides video images, free from environmental glare, to one eye at a time (either left or right) of content transmitted via a receiver within a casing mounted to headgear, such as a cap, by a spring-loaded clip.

2. Description Of The Related Art

In an age of wireless telecommunications and extreme mobility, numerous ways for viewing video content, such as pictures and data with sounds, have emerged to allow users to access media while they are away from their offices or computers, engaged in outdoor or remote activities or are simply relaxing in locations where traditional or larger displays or receivers are unavailable or impractical. These devices typically require some form of electronic display, an optical system to enhance or enable the viewing of that display, an electronic means to receive, store and transmit content to the display for presentation, and a means for powering the device.

Two of the most common forms of such mobile viewing are portable televisions and video game players. Although these devices use battery-powered displays and have the ability to receive or store content for presentation, they are limited in their ability to deliver satisfactory video images outdoors because their displays are subject to “washout” or glare from bright sunlight or surroundings. Further, because such devices are typically handheld, their screen sizes are small and thus “distance” the user from many of the details that would normally be seen on the display screen of a larger, less portable device.

An effective means to prevent both washout and loss of detail is to employ in portable displays a technique which has been used successfully in binoculars and camcorders. By adding a soft rubber eyecup, the optics and display can be placed in close proximity to the eye and sealed snugly so that detail can be observed through an apparent increase in screen or image size, and stray glare from the environment is minimized. However devices which adopt this method encounter new problems, among them: (a) finding ways to adjust and hold the combined eyecup/display in a comfortable yet functional position close to the eyes; and (b) permitting the user free use of both hands while in the process of viewing.

Past solutions to these problems have produced exotic and expensively designed heads-up displays or head mounted displays. Heads-up displays typically involve the presentation of video-generated images which are superimposed on top of, or into, a user's line of sight of the real world through the use of image reflection or image projection devices such as prisms and mirrors or specially coated glazings. Such displays can be free-standing, for example as a device mounted to the top of an automobile's instrument panel in the driver's line of sight; reflected onto another component in the driver's line of sight, such as the windshield; or onto an optical display panel built into a helmet or headpiece worn by the driver. Heads-up or head mounted displays, such as those worn by combat pilots, often include not only all of the display and viewing elements necessary, but also the operational components described above and a means for mounting these elements and fitting the assembly comfortably to the head of a potential user. Such devices are referred to as “head mounted displays” or “HMDs.” As much design and manufacturing effort typically has gone into the “head mount” portion of HMDs as into the “display” portion.

Helmet Styles

Early binocular and monocular HMDs were developed for combat troops and aircraft applications such as targeting and night vision. Typically, these HMDs were incorporated into hard shell helmets which were large, heavy and cumbersome, with the combined HMD-helmet unit highly integrated. Additionally, helmets are now being used for “immersive experiences” such as virtual reality, with some providing 3-D visuals and wrap-around sound.

Mask Styles

“Mask” styles, as do helmets, integrate the functional elements of a display system, i.e., the optics, the display, the electronics drivers, and the receiver(s) or storage device(s)—into a simpler form of helmet or into an elaborate, fully adjustable face mask or headband. Such masks or headbands must be designed to accommodate a wide range of head shapes and sizes, and a broad range of price points and consumer profiles, most of which are today both high-end and upscale. For such products, as much development and investment typically goes into the “mount” as it does the “display.” The HMD products marketed have varied widely in consumer acceptance. Some potential users have found themselves uncomfortable, intimidated, embarrassed or simply “turned off” by the idea of having to wear an elaborate piece of head gear simply to watch a video image portably. Past efforts at creating mask style HMDs often have resulted in devices that make their users feel quite self-conscious and perceiving themselves as looking like a robot, an alien, a nerd, a show-off, a fool or an idiot. For this reason, and because they are also expensive, mask style HMDs have not been popular in the marketplace.

Eyeglass Styles

Efforts to make HMDs “blend-in” or to become more acceptable to consumers have resulted in combinations of optics and displays that are integrated into what appear to be common eyeglasses. Such attempts have resulted in bulky or cumbersome frames, thick or costly lenses or expensive components due to the need for miniaturization. Often these configurations require the remote placement of systems or components such as batteries in order to preserve and simulate eyeglass styles acceptable to consumers. Even so, because many people object to wearing expensive glasses of any kind, eyeglass styles have achieved only marginal success.

U.S. Pat. Nos. 5,815,126 and 6,452,572 B1 to J. C. C. Fan et al. disclose a monocular portable system that includes a matrix display mounted within a housing positioned relative to one eye. The display is connected to a video or other information source providing images or data. A supporting harness holds the display on the user's head. In one embodiment the display is mounted to an arm adjustably extendable from the harness so the display can be moved laterally in and out of the eye's field-of-view or from one eye to the other without adjusting the harness. In another embodiment the display is pivotable vertically so that the user can move it upwards out of the field-of-view.

U.S. Pat. No. 5,471,678 to A. Dor discloses a flip-up mount for a night vision system which can be either a monocular or binocular device. The mount includes a pivotal armature attached to a carriage which engages a coupling on the night vision system. The armature pivots between a position enabling an operator to use the system, and a tilt-up stowed position.

U.S. Pat. No. 5,003,300 to B. A. Wells discloses a head mounted, monocular display for video imagery. A virtual raster display unit is attached to the user's head by a U-shaped harness which grips the sides and back of the head, or is attached to a conventional helmet or to the user's eyeglasses. The display unit can be positioned by a support member pivotally attached to the harness or helmet either in an eye's field-of-view or in a tilt-up stowed position.

U.S. Pat. No. 5,642,221 to R. E. Fischer et al. discloses a head mounted binocular display system for viewing video or other imagery. A display unit is supported by a headband with three independent adjustments: a pivot adjustment proximate to the ears; a pivot adjustment proximate to the eyes; and an adjustment which permits the unit to be displaced fore and aft from the wearer's head to permit convenient use with eyeglasses.

### OBJECTIVES AND ADVANTAGES OF THE INVENTION

The objectives of the present invention are threefold: (a) create a simple, lightweight, truly affordable and efficient HMD; (b) remove physical discomforts and psychological stigma associated with wearing a strange-looking HMD in public; and (c) eliminate the necessity of researching, designing, manufacturing, distributing, servicing and providing warranties for an independent mount system solely for the purpose of supporting the display system. The system of the present invention integrates the optics, the display, and the electronics drivers, receivers and/or storage devices into a compact package to be worn on the head, but with a mounting system that incorporates caps, hats or other headgear that may be conventional or novel.

Commonly Worn Apparel

The baseball cap, (and similar apparel) have emerged as fashion statements unto themselves. For example, such caps carry the names, colors and logos of countless sports teams, clubs, schools, universities, institutions, corporate entities, film and rock stars, fictional characters, themed entertainment venues, movie titles, product promotions, military forces, law enforcement, governmental bodies and political causes; the list is truly endless. Ball caps are worn by men and women, young and old, children and adults, in all weather, day or night, frontwards, backwards or sideways, are available everywhere and accepted worldwide. Although the display system of the present invention can be fitted to other types of apparel, such as a headband with a visor, the baseball cap is the most preferred headgear for use with the system of the present invention. Some of the advantages of the system of the present invention, when used with a baseball cap, are as follows:

1. By clamping a display system of the present invention to the visor of a baseball cap the need to design, make, sell or service a fully adjustable companion head-mounting system to fit all ergonomic percentiles and HMD user profiles is eliminated.

2. By clamping a display system of the present invention to the visor of a baseball cap a user is always assured of the availability of a clean, comfortable, undamaged mounting system wherever he might travel worldwide.

3. By clamping a display system of the present invention to the visor of a baseball cap a user can eliminate the stigma of wearing a foreign, odd-looking, peculiar or embarrassing piece of equipment in public surroundings.

4. Conversely, by clamping a display system of the present invention onto the visor of a favorite ball cap a user can make a fashion statement and/or continue to express his individuality and, indeed, can “personalize” the HMD should he desire to do so.

5. By clamping a display system of the present invention to the visor of a baseball cap the HMD manufacturer or retailer can attract or participate in marketing promotions with numerous companies, teams, organizations, institutions or entities which can stimulate further sales and use of the invention.

6. By clamping a display system of the present invention to the visor of a baseball cap a user can easily remove the HMD for storage or safekeeping.

7. By clamping a display system of the present invention to the visor of a baseball cap a user can easily transfer the HMD to another ballcap or to another article of clothing without damage to either the HMD or the clothing.

8. By clamping a display system of the present invention to the visor of a baseball cap a user can easily adjust the HMD laterally to accommodate for wide or narrow eye spacing, an adjustment that might otherwise be difficult or require more complex mechanisms to accomplish.

9. By clamping a display system of the present invention to the visor of a baseball cap the invention may be slid forward or aft to accommodate unique headforms or allow conventional eyeglasses to be worn.

10. By clamping a display system of the present invention to the visor of a baseball cap the electronics and display portion of the invention is protected from solar infrared and ultraviolet radiation, and shielded from cold, heat, rain, snow and other elements which might otherwise require more elaborate casing or insulation.

11. By clamping a display system of the present invention to the visor of a baseball cap a user can quickly and easily remove the HMD in the event of an emergency, upon entry into a vehicle or similar circumstance, or quickly share the HMD with another person.

12. By clamping a display system of the present invention to the visor of a baseball cap a user of the invention can rotate the HMD to the side, or alternatively 180° to the rear, to quickly restore his full field-of-view, or store the HMD (in a rearward position) while it remains on his head.

13. By clamping a display system of the present invention to the visor of a baseball cap the HMD can be carried in the 180° rearward (stored) position where it cannot be damaged or cause damage to a user should he fall or collide with a person or inert object. Such placement or storage is generally not feasible or practical with other types of HMDs.

14. By clamping a display system of the present invention to the visor of a baseball cap a user can raise the visor of the cap upwards to quickly provide an unobstructed full field-of-view in the event of an emergency. Such movements are not always possible or practical with other types of HMDs.

15. By clamping a display system of the present invention to the visor of a baseball cap the HMD contributes to the structural integrity of the baseball cap and thus facilitates easy adjustment of the cap to various headforms, ergonomic profiles and positions.

16. By clamping a display system of the present invention to the visor of a baseball cap a user can monitor a visual display with one eye and his immediate surroundings with the other eye, or he can superimpose each of these views simultaneously or alternatively.

17. By clamping a display system of the present invention to the visor of a baseball cap a user can free both hands for use in other tasks.

### PREFERRED APPLICATIONS FOR THE INVENTION

As an HMD for operating Video Radio Control (“VRC”) toys, Remotely Operated Vehicles (“ROVs”), Remotely Piloted Vehicles (“RPVs”) or for use onboard Unmanned Combat Air Vehicles (“UCAVs”) equipped with wireless video and telecommunications.

As a monocular see-through display in which computer graphics are superimposed over a user's view of the world. Such systems preferably use a prism or mirror to reflect images from a liquid crystal display (LCD) into the user's line-of-sight while still allowing light to pass through to his eyes.

As a binocular see-through display in which computer graphics are superimposed over a user's view of the world using stereoscopic prisms to reflect images from a pair of LCDs into the user's line-of-sight while still allowing light to pass through to his eyes.

As a remote viewfinder for camcorders, security systems, educational systems or other forms of electronic imaging.

As a means of providing access to video manuals or inventory spread sheets to field workers, repair technicians or medical personnel who need to have both hands free to work.

As an adjunct to gaming systems and devices in which sensors and targets keep track of position and orientation of a user's head to ensure that graphics introduced through related audio/video content systems appear in the correct places relative to the user's movements.

As a component of eye-tracking and aiming devices in which virtual reality type position sensors are used to detect head orientation and eye movements.

As an electronic night vision display when using a monochromatic video camera coupled to an infrared illumination source.

As a portable TV or video gaming device.

All, or combinations of the above for use in rugged, remote, hostile or emergency environments where larger forms of headgear (such as helmets) are either unnecessary or unavailable.

### SUMMARY OF THE INVENTION

These and other objectives, advantages and applications are achieved by the present invention which in one aspect provides a monocular display system, mounted to a headgear portion, which includes: a casing; a mounting device attached to the casing detachably affixing the casing to the headgear portion and maintaining the casing aligned with and substantially parallel to the headgear portion; an arm attached to the casing and pivotable about a first axis orthogonal to the casing; and an optics assembly having an end attached to a housing, containing a display assembly, attached to the arm and pivotable about a second axis orthogonal to the casing and parallel to the first axis.

In another aspect the invention provides a monocular display system, mounted to a headgear portion, which includes a primary casing having upper and lower portions interfacing at a mating flange determining a reference plane, and a spring mounting clip attached to the casing upper portion used to detachably affix the casing to the headgear portion. The display system further includes an adjustment arm having two portions determining upper and lower flanges. The upper flange is pivotally attached to the casing lower portion, the arm and flanges are parallel to the reference plane, and the arm is pivotable at the upper flange about a first axis orthogonal to the reference plane. The display system further includes an optics assembly having a focus mechanism assembly whose first end is connected to an eyecup and whose second end is attached to a housing containing a display and backlight assembly. The housing is attached to a gimbal which is attached to the lower flange and is pivotable about a second axis orthogonal to the reference plane and parallel to the first axis.

In still another aspect the invention provides a monocular display system mounted to a baseball-type cap visor. The display system includes a primary casing having upper and lower portions interfacing at a mating flange determining a reference plane. The casing upper portion is contoured so as to shape and support the underside of the visor, and the casing lower portion has therethrough a generally circular hole. The display system further includes a spring mounting clip attached to the casing upper portion which detachably affixes the casing to the visor. The display system further includes an adjustment arm having two portions determining upper and lower mating flanges. The upper flange is pivotally attached to the casing lower portion. The arm and flanges are parallel to the reference plane, and the arm is pivotable at the upper flange about a first axis orthogonal to the reference plane. The display system further includes an optics assembly having a focus mechanism assembly connected at one end to an eyecup, and attached at its other end to a display housing containing a display and backlight assembly. The housing is attached to a gimbal attached to the lower flange which is pivotable about a second axis orthogonal to the reference plane and parallel to the first axis.

A more complete understanding of the present invention and other aspects and advantages thereof will be gained from a consideration of the following description of the preferred embodiment in conjunction with the accompanying drawing figures provided herein. In the figures and description, numerals indicate the various features of the invention, like numerals referring to like features throughout both the drawings and description.

### BRIEF DESCRIPTION OF THE DRAWINGS

FIG. 1 is an exploded perspective view of a primary casing and spring mounting clip for a preferred embodiment of a cap-mounted monocular video/audio display system according to the present invention.

FIG. 2 is a cross-section of the FIG. 1 primary casing taken along the lines 2-2.

FIG. 3 is an exploded perspective view of an optics assembly of the FIG. 1 embodiment including a gimbaled housing containing a display and backlight assembly, an optical train of focusing and viewing lenses, and an eyecup.

FIG. 4A schematically shows a top plan view of the FIG. 1 casing mounted to a cap visor, with the FIG. 3 optics assembly mounted to the casing by a pivotable adjustment arm.

FIG. 4B schematically shows a front view of the FIG. 1 casing, FIG. 3 optics assembly, and FIG. 4A adjustment arm.

FIG. 5 is a cross-section of the FIG. 4A adjustment arm taken along the lines 5-5.

FIG. 6 schematically shows a side view of the FIGS. 4A and 4B casing and optics assembly.

FIG. 7 is a perspective view of a preferred embodiment circuit board configuration having a ribbon cable management system attached to the display and backlight assembly.

FIG. 8 schematically shows a top plan view of the FIGS. 4A, 4B adjustment arm and the FIG. 7 ribbon cable management system pivoted from a first to a second position of rotation.

FIG. 9 is a top-level exploded perspective view of the display system detachably affixed to the FIGS. 4A, 4B cap visor, showing the FIG. 1 casing and spring mounting clip, the FIG. 3 optics assembly, an audio output cable, a battery pack, a clip for attaching the cable to the visor, and an earphone.

FIG. 9A is a detail perspective view of the FIG. 9 cable clip.

FIG. 10 is a block diagram of a preferred embodiment of the video/audio electronics configuration of the present invention.

### DETAILED DESCRIPTION OF THE PREFERRED EMBODIMENTS

As used herein, the term “detachably affixed” means that an element of the embodiment (e.g., the primary casing) can be conveniently and repetitively affixed to and detached from a headgear portion (e.g., a cap visor) without any specialized adaptor(s), tool(s), adhesive(s) or user skill(s). The term “attached” means that the elements referred to are permanently joined or at least not easily separable. The term “connected” means that the elements referred to are easily separable.

In all preferred embodiments of the present invention, the HMD display system includes a primary casing, a pivotable adjustment arm, and an optics assembly combining a display and backlight assembly (or a display only assembly) mounted in a housing, a plurality of viewing lenses, and an eyecup, which collectively form the housing and operating structures of the HMD. These structures also serve to mount the HMD's internal mechanical and electronic operating components. Constructed preferably of conventional plastics, the HMD's primary casing incorporates conventional bearing surfaces, attachment points, bosses, internal seals and coloration to provide an attractive, articulated, protective shell for the electronic circuit boards, optics and wiring and serves as a platform for the adjustment arm. The primary casing structure preferably includes two injection-molded plastic shells, that when joined conform to, shape and reinforce the visor of a standard baseball cap, provide a surface against which the HMD will secure itself against the baseball cap's visor, and provide for attachment to the HMD's clamping mechanism. An assembly of adjustable, telescoping focus rings hold the viewing lenses the correct distance from a user's eye and, in that position, provide for gradual movement of the lenses along the optic axis to assure proper focus at the image plane. A soft rubber eyecup which prevents unwanted light from entering the viewing lenses, is connected to a lens retainer bezel. The preferred configuration for the cap-mounted HMD is monocular, with the optics assembly and adjustment arm adapted to accommodate either eye, one at a time. In this way, while one eye is viewing an image presented on the display, the other can monitor an unobstructed view of the user's surroundings. Alternatively, either eye can be selectively closed to produce an exclusive view for the selected eye.

In accordance with the principles of the present invention the display system is preferably secured to the visor of a standard baseball cap. Alternatively, the display system could be attached in similar fashion under the brims, bills or visors of numerous types of hats, caps, helmets or other headgear. In the preferred embodiment described in detail herein, a pre-tensioned, spring-loaded, stainless steel wire clamp opens sufficiently to allow the primary casing to slip non-destructively beneath the cap's visor with the spring clamp above pinching the visor between. In so doing, sufficient clamping force is exerted to hold the display system securely in place, yet allow for its periodic adjustment either laterally, or forward and aft to accommodate various facial ergonomics and/or head sizes, with or without eye glasses. The spring-loaded clamp permits single-handed, slide-on/slide-off removal, transfer and re-installation of the display system, i.e., removable attachment. The clamp also permits the display system to be detachably affixed to other types of headgear such as a hat with a brim.

A preferred embodiment of the optics assembly includes a lens and focus mechanism, and a video display panel and backlight. Also in accordance with the principles of the present invention, a printed circuit board containing a radio frequency (“RF”) video/audio receiver and antenna array with its connection to the electronics driver circuitry for the video display is incorporated within the primary casing. Most preferably, the antenna of the present invention is of a “conformal” type. This most preferred antenna is contained entirely within the primary casing rather than placed externally where it could become damaged, hook on clothing, or interfere with a user's surroundings or with ease of operation. Powered through either internal batteries or an external, portable power pack and with content supplied through its on-board video/audio receiver or an externally connected content storage/delivery device, the display places a black and white or color video image at the image plane to be resolved using the optics assembly described herein.

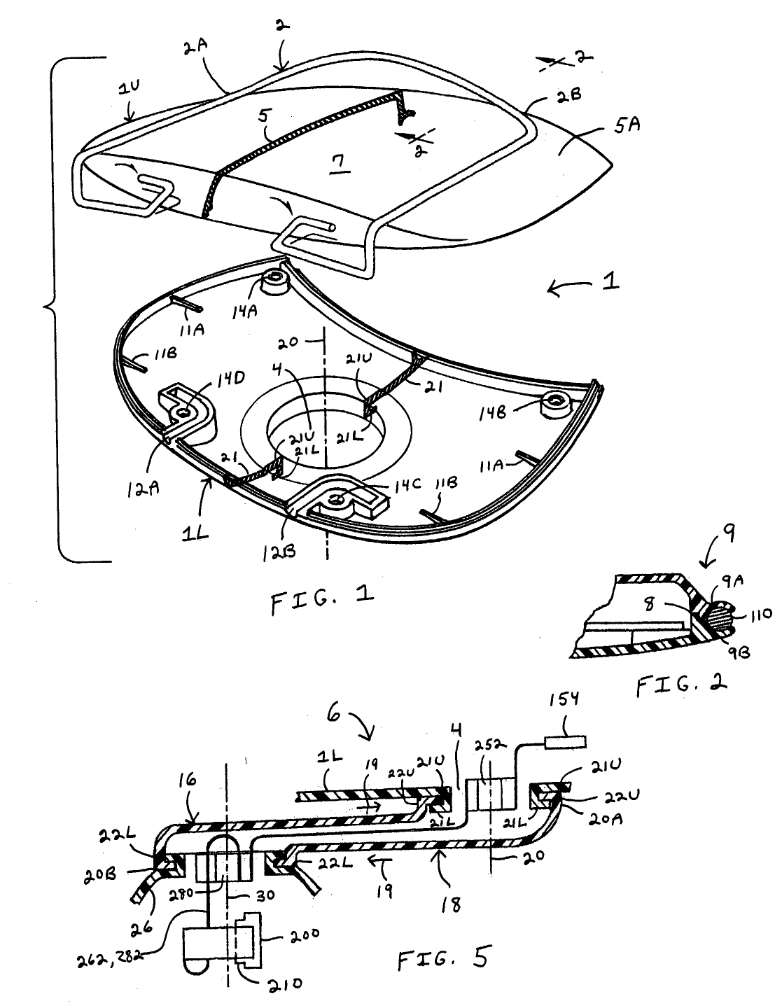

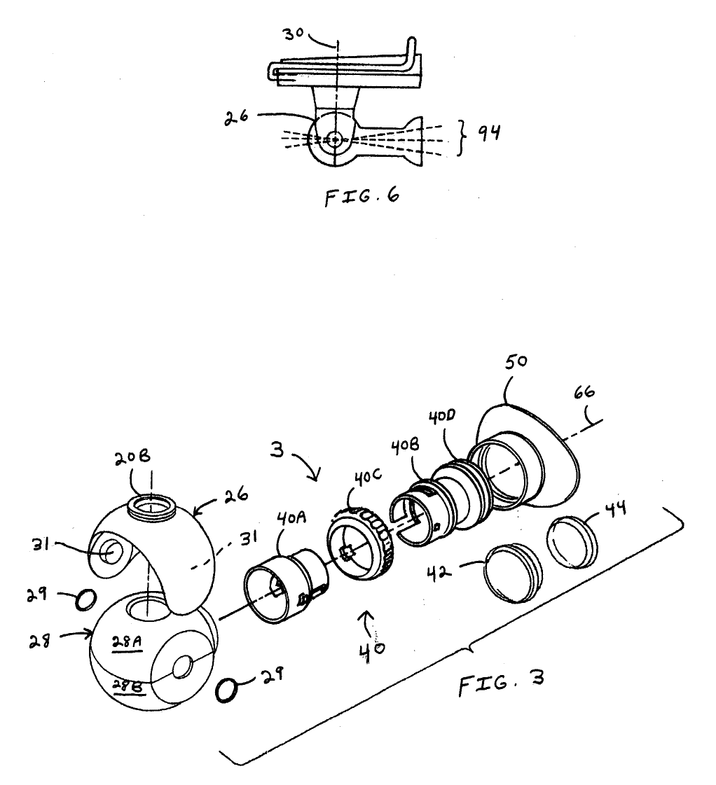

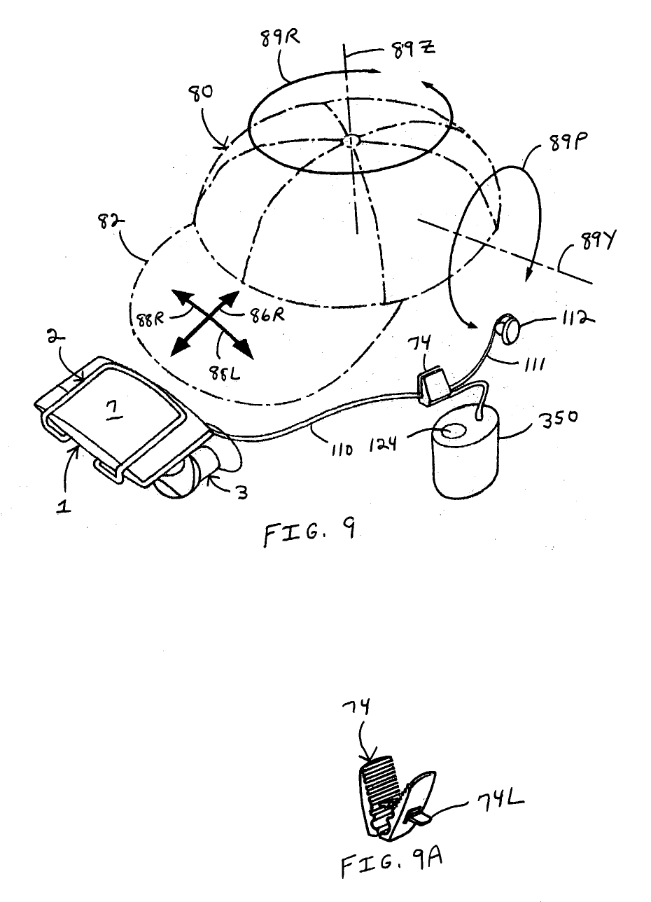

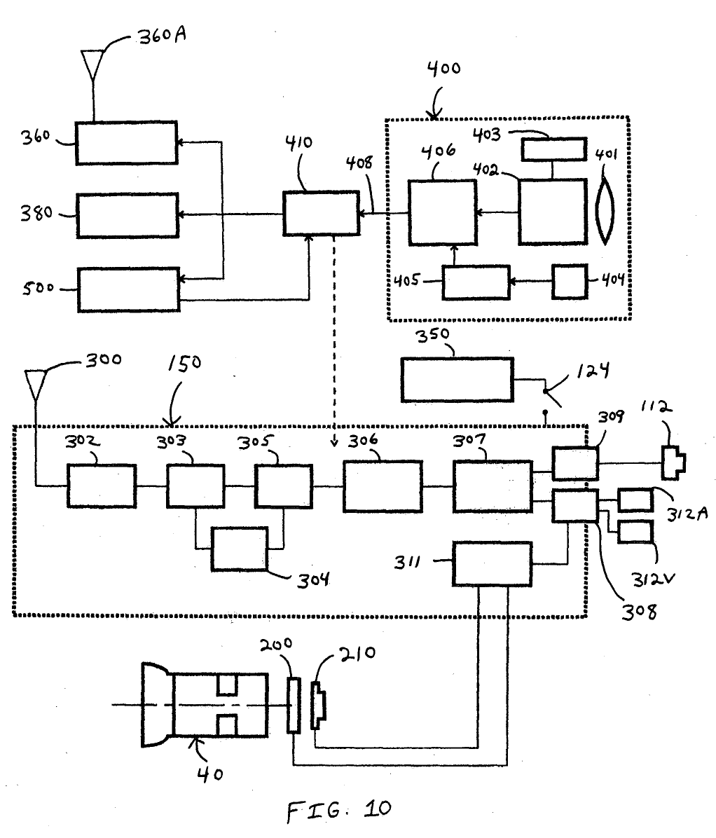

Referring to FIGS. 1 and 2, in a preferred embodiment according to the present invention a display system 10 includes a primary casing 1 having upper and lower portions 1U, 1L, respectively, and a spring mounting clip 2 which collectively comprise structures for mounting the display system 10 to various types of caps and other headgear. Casing lower portion 1L incorporates a bearing surface and retaining flange for mounting a pivotable adjustment arm 6 (shown in detailed cross-section in FIG. 5). Casing upper portion 1U is contoured in two directions, as shown by cross-section 5 and contour 5A. These contours function to support and shape the underside of a typical baseball cap visor and may be modified to accommodate different cap styles. The upper surface 7 of portion 1U may be textured or coated to further enable gripping of a visor underside or hat brim, or other apparel if desired or necessary. For example, surface 7 may incorporate an injection molded texture; alternatively, elastomeric coatings could be spray applied. However, such texturing or coating is not preferred in the embodiment described in detail herein. As shown in FIG. 1, casing portion 1L has a cross-section 21. As shown in FIG. 2, casing portions 1U and 1L are configured to interface snugly against each other at a mating flange 8 determining a reference plane, to seal and protect the components inside. Recesses 14A, 14B, 14C and 14D provide bores through which screws may be used to attach casing portion 1U to casing portion 1L. As further shown in FIG. 2, the rearward edge of casing 1 incorporates a channel 9 into which an audio microphone and power cord 110 (see FIG. 9) and/or a media input cable is secured and protected. Channel 9 includes an arcuate upper portion 9A attached to or formed integrally with casing portion 1U, and an arcuate lower portion 9B attached to or formed integrally with casing portion 1L. Although molded from high-impact polycarbonate plastic, channel portions 9A and 9B allow for press-in insertion or tension removal of cord 110. Casing portions 1U and 1L include molded-in positioning shoulders 11A, 11B for centering and securing an electronics printed circuit board (see FIG. 7). Two spring clip mounting channels 12A, 12B are molded into the interior surface of casing portion 1L. Corresponding channels are molded into the interior surface of casing portion 1U, but are not shown in FIG. 1. The mounting channels secure the spring mounting clip 2 to casing 1. In one preferred embodiment, vent holes placed at various locations in the primary casing allow cooling airflow to the electronics within the casing. Such vents, for example, could be included along the casing rearward edge.

Polycarbonate (sometimes referred to by its trade name LEXAN™ and manufactured by General Electric Corporation) is the preferred material for the casing components shown in FIGS. 1 and 2 due to this plastic's inherent strength, impact resistance, engineering qualities, coloration availability and resistance to moisture.

Referring to FIGS. 1 and 5, casing lower portion 1L further includes a generally circular hole 4 therethrough concentric with a generally vertical axis 20 and sized to accommodate a ribbon cable management system 170 (see FIGS. 7, 8). Hole 4 is transected by cross-section 21 which terminates in an annular hook-shaped end portion having upper and lower surfaces 21U, 21L, respectively. The arm 6 has first and second portions 16 and 18, respectively, determining when interlocked generally circular upper and lower mating flanges 22U, 22L, respectively. Assembly of arm 6 is accomplished by sliding portions 16 and 18 in opposite directions, as shown by opposed arrows 19, until flanges 22U and 22L are snug, and simultaneously clamping about cross-section 21, at 20A, and gimbal 26, at 20B, thereby forming generally circular upper and lower bearing surfaces 21U, 21L, respectively, so that arm 6 is pivotable about vertical axis 20 and can be rotated from one position to another.

Referring to FIGS. 3 and 5, an optics assembly 3 includes a gimbal 26 attached to a generally spherical display housing 28. Gimbal 26 includes a top flange 20B. Optics assembly 3 further includes a commercially available focus mechanism assembly 40 including telescoping focus rings 40A and 40B, a manually adjustable focus ring 40C, and a lens retainer bezel 40D. Plastic lens elements 42 and 44 are conventionally snap-inserted into bezel 40D. A soft rubber eyecup 50 connects to bezel 40D at the viewing end of assembly 3. Display housing 28 includes upper and lower hemispheres 28A, 28B, respectively, conventionally joined through mechanical fasteners (not shown). Assembly is accomplished by joining hemispheres 28A and 28B around molded-in spindles 31 in each side of gimbal 26. Elastomer “O” rings 29 inserted over spindles 31 prior to assembly produce a desired friction to hold the display housing 28 in position on gimbal 26 once it has been adjusted so that eyecup 50 fits a user's eye, and assure continued flexibility and ease of adjustment. Display housing 28 incorporates internal bosses molded-in to hemispheres 28A and 28B to accept a commercially available display and backlight assembly 180 (see FIG. 7). Alternatively, the backlight is omitted so that housing 28 contains a display assembly rather than a display and backlight assembly. Eyecup 50 can be rotated about optic axis 66 for user comfort and to prevent unwanted light from reaching the display. If eyecup 50 is of an asymmetric design, it can be rotated 180° about axis 66 to better seal against the eye on the opposite side of the user's face.

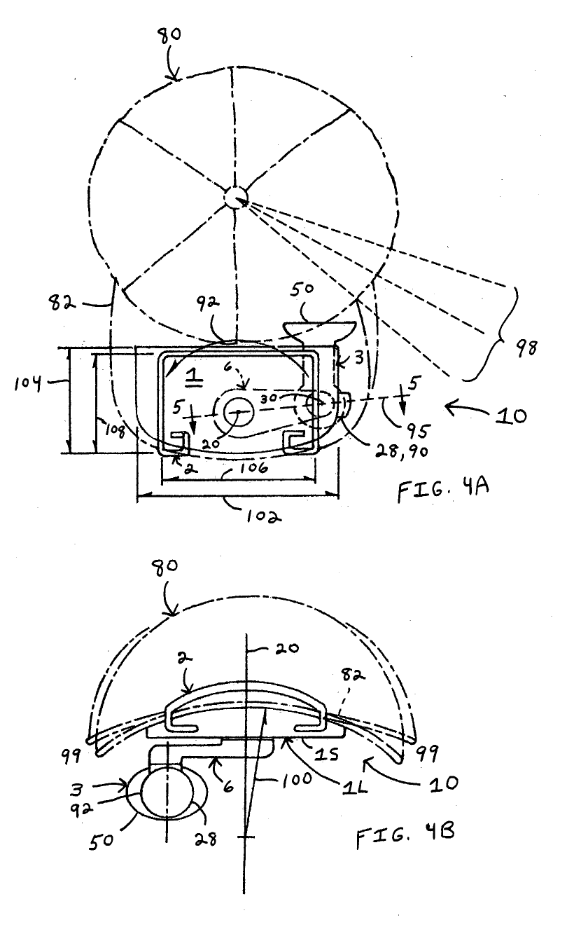

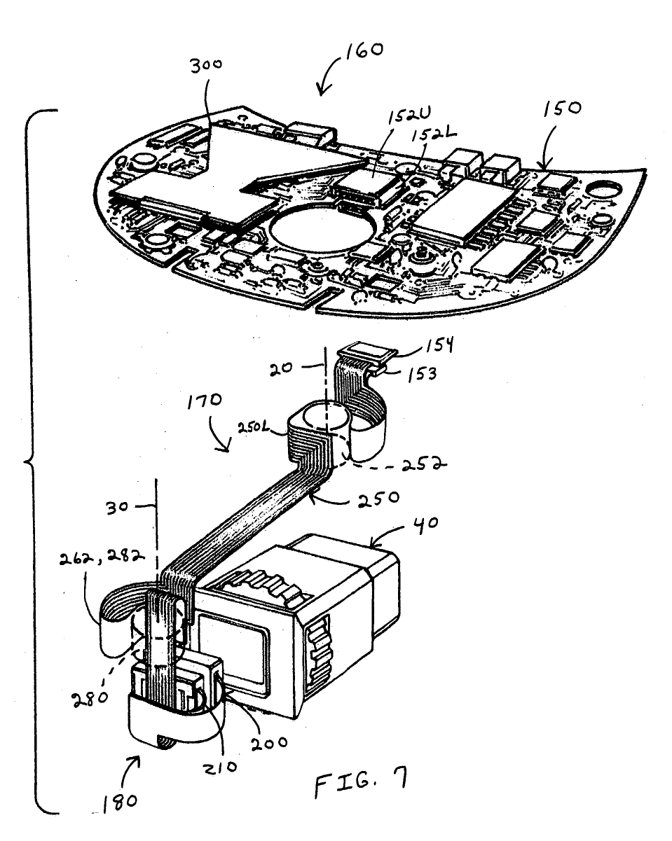

FIGS. 4A and 4B schematically illustrate the display system 10 detachably affixed to a standard baseball cap 80. Thus, by definition, the display system becomes an HMD. The primary casing 1, adjustment arm 6 and optical assembly 3 are shown in their proper relationship to each other. FIGS. 4A, 4B and 9 further show the HMD to be detachably affixed to visor 82 of cap 80. The FIG. 9 exploded perspective view shows the HMD as it would appear just prior to attachment to the visor, or just after removal. The HMD is secured to the visor by clamping pressure applied by spring mounting clip 2 against the upper surface 7 of primary casing 1 at points 2A and 2B (see FIG. 1). The HMD is slid onto the cap visor by slightly separating spring clamp 2 from surface 7 and then sliding the HMD in a rearwards direction as indicated by arrow 86R in FIG. 9. The HMD is removed simply by sliding it forward off the end of the cap visor. Although the optics assembly 3 is highly adjustable through rotation about axes 30 and 66 and rotation with respect to gimbal 26, additional adjustment is possible by sliding the entire HMD left or right against the surface of the visor as indicated by arrows 88L, 88R. Moreover, as indicated by indicia 89R, 89P, other adjustments are possible by rotating the cap clockwise or counterclockwise about axis 89Z and/or adjusting the visor's pitch (i.e., rake) about axis 89Y, respectively. As shown in FIGS. 9 and 9A, a clip 74 secures the cord 110 and an earpiece 112 to the lower edge of cap 80 where desired.

Rotation of adjustment arm 6 around vertical axis 20 and rotation of optics assembly 3 around vertical axis 30 allow eyecup 50 to be aligned with a user's right or left eye, and/or to be spaced forward or aft for user comfort or to accommodate the wearing of standard eyeglasses. Movement of the display housing 28 about axis 30 and rotation of the eyecup 50 about axis 66 allows the eyecup to be adjusted in order to arrive at an orientation most comfortable to the user. Because wiring and electrical connections are routed from the primary casing 1 through arm 6 into optics assembly 3, stops are incorporated in flanges 4A and 20B to prevent rotations greater than 350°, thus assuring there will be no damage to the HMD's internal electronic connections.

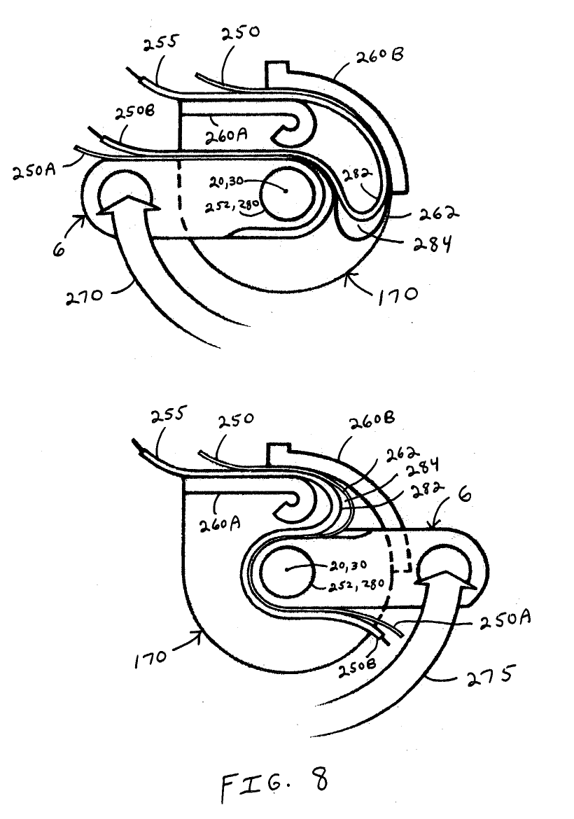

Pivotal movement of the adjustment arm 6 and optics assembly 3 is further illustrated in FIGS. 4A and 4B. Repositioning for the left or right eye is accomplished by pivoting arm 6 about axis 20, as indicated in FIG. 4A by arrow 92, in an adjustment for the right eye. Still referring to FIG. 4A, such adjustments generally require pivoting arm 6 about axis 20 in a clockwise direction, then pivoting optics assembly 3 about vertical axis 30 in a counterclockwise direction, and making a final vertical adjustment as indicated in FIG. 6 by arrows 94. By terminating the pivotal rotations about axes 20 and 30 at a point of comfort for the user, wherein the eyecup is aligned to the user's eye or against the surface of eyeglasses should the user be wearing them, then with the eyecup aligned vertically by adjusting the optic axis 66 upwards or downwards as shown by the arrows 94, the image from the display and backlight assembly 180 can be precisely centered within the eyecup for all of the human percentiles in the target user market, from child through adult. In the FIG. 4A view looking down, the optics assembly 3 shown at 90 is positioned so eyecup 50 is adjusted for the user's left eye. In the FIG. 4B view looking rearward, the optics assembly 3 shown at 92 is positioned so eyecup 50 is adjusted for the user's right eye. To accommodate various user cap position preferences, it is further possible to adjust the eyecup's horizontal optic axis as shown at 94 of FIG. 6, by rotating gimbal 26 about axis 30. Alternatively, it is possible to eliminate this additional angle adjustment since it is possible for some users to achieve positioning comfort by moving the cap itself. There are also alternative configurations and alternate pivot positions for achieving the full range of adjustments that may be desired by users, such as incorporating a ball swivel joint at the upper center of display housing 28 at flange 20B, or at the point 20A (see FIG. 5) where arm 6 is attached to the bottom of casing 1. It is further a preferred embodiment of the present invention to make arm 6 of a flexible material which would be able to torque about its lateral axis 95 (see FIG. 4A) to thereby provide the necessary vertical eyecup adjustment.

FIGS. 4A and 4B show schematically how, in a typical baseball cap, increasing the lateral curvature of the visor will reduce the diameter of the headband, which can be helpful in accommodating smaller head sizes or proportions. This can occur when the cap is placed on a smaller head and/or the visor is manually recontoured to a greater curvature. Such changes generally occur along a conical axis in the forward quarters of the cap about the cap's plan view center (as indicated at 98 of FIG. 4A), and resolve themselves near the left and right edges of the visor (as indicated at 99 of FIG. 4B). For this reason, upper surface 7 and lateral contour 5A of casing 1 (see FIG. 1) are preferably contoured within a range of curvatures sufficient to maintain apparel flexibility and traditional comfort adjustments inherent to a baseball cap. Specifically, upper surface 7 at contour 5A is most preferably formed with a circular arc whose center lies in a plane generally orthogonal to bottom surface 1S of casing portion 1L and whose transverse radius is in a range from 3.9 inches to 4.2 inches (as shown by radius 100 in FIG. 4B). To further permit flexibility the overall width of casing 1 should be held, preferably, to approximately 4.0 inches (as shown at 102 of FIG. 4A) with a forward and aft depth of approximately 2.30 inches (as shown at 104). Similarly, the spring mounting clip 2 should be held, preferably, to approximately 3.15 inches in lateral width (as shown at 106) and approximately 2.40 inches in depth (as shown at 108). The foregoing dimensions are not absolute, but are preferred, based on the use of standard baseball caps such as those proposed in the preferred embodiment.

Referring again to FIG. 9, cable 110 provides audio output via wire 111 to earphone 112 positioned in the desired ear, while clip 74 attaches cable 110 to the desired side of the cap 80. Cable 110 also delivers battery power to the HMD from a battery pack 350 which can be carried in the user's pocket, clipped to the user's belt or, if sufficiently small and light, be incorporated into casing 1. Power is controlled at the battery pack by switch 124. As shown in FIG. 9A, clip 74 preferably includes a conventional, quick-release lever 74L for easy removal of either the cap or the battery pack. Also, clip 74 may include an input jack so that video and/or audio from an external device can be easily connected to enable delivery of video and/or audio to the HMD. A similar input jack can also be added to primary casing 1 for this purpose. In another preferred embodiment, casing 1 may include RCA type video/audio output jacks so that video/audio transmissions received via an internal antenna and receiver system can be processed and output to a conventional video monitor or television set. FIG. 10 is a block diagram showing the interface of other electronics such as a video camera with the display and backlight assembly 180.

FIG. 7 is a perspective view of a preferred circuit board configuration 160 shown with its ribbon cable management system 170 having a ribbon “interconnect” cable 250 attached to the display and backlight assembly 180. Ribbon cable, which is thin and flexible, has printed circuitry on its surface to carry electrical signals, and is commonly known as “flex-circuit interconnect cable.” Such cables are made by Minco Products, 7300 Commerce Lane, Minneapolis, Minn. 55432. The Kopin AMLCD CyberDisplay 320 described below and preferred for use in the display and backlight assembly 180 presently requires an interconnect cable with twenty wires, and four additional wires for the backlight. Maintaining this connectivity through adjustment arm 6, which must pass electronics wiring through hollow centers spaced approximately 1.6 inches apart and which further pivots about those centers more than 180° and which can turn 90° at both ends, requires both an interconnect cable fitting easily inside arm 6 and a pivot mechanism. Cable management system 170 includes a loop 250L of ribbon cable which rolls and unrolls as the interconnect cable 250 pivots within arm 6 and about axes 20 and 30. The size of the loop is dictated by the minimum bend radius of the flex-circuit material available; the ribbon material can bend freely in only one plane.

FIGS. 7 and 8 illustrate structures that function to coil and uncoil the 20-wire interconnect 250 as it pivots around parallel axes 20 and 30 and maintains a plane essentially perpendicular to the axes of rotation. Rotation about axes 20 and 30 each allow for rotations in excess of 1800. FIG. 7 shows an antenna 300 attached to circuit board 150. Board 150 includes superposed upper and lower sockets 152U, 152L, respectively, proximate to a generally circular hole 150H whose center coincides with axis 20. Socket 152U accepts an imager connector 154 (see FIG. 5), and socket 152L accepts a backlight connector 153. Interconnect cable 250 passes through hole 150H around pivot axis 20 where it turns 90° and forms the loop 250L which grows or shrinks as arm 6 rotates; in so doing, it retains a natural curve that is within the design limitations of the printed circuit ribbon material. In FIG. 7, a hub-like region 252 at axis 20 (seen also in FIGS. 5 and 8), around which loop 250L is constrained to curve, is depicted as a dashed cylinder. As the parts rotate, the interconnect cable 250 at 262 and 282 turns 90° to lie flat inside arm 6, guided by surfaces 260A and 260B (see FIG. 8). In FIG. 7, a hub-like region 280 at axis 30, around which loops 262 and 282 are constrained to curve, similarly is depicted as a dashed cylinder. FIG. 8 shows a typical pivot diagram for the cable management system 170 in preferred embodiments of the present invention. In this view, which is perpendicular to the axes of rotation 20, 30, two ribbon cables, the display interconnect 250 and the backlight circuit interconnect 255, enter adjustment arm 6 through two curved walls 260A and 260B which serve to constrain the loops of ribbon material 262, 282 to acceptable shapes. When arm 6 is moved clockwise (indicated by arrow 270) around the region 280 (see FIG. 5) the loops grow in size. When the arm is moved counterclockwise (indicated by arrow 275) the loops shrinks. Several ribbon cables or combinations of ribbon cable and flexible wiring can be accommodated as long as sufficient space 284 is left between the concentric loops to allow for their differing circumferences caused by differing radial distances from the axis of rotation. Imager circuit 250A and backlight circuit 250B exit along the surface of arm 6. Mechanical stops are incorporated into polycarbonate bearing surfaces between arm portions 16, 18 and flange 4A of casing 1 (see FIG. 5 at 20A) using conventional practice, and also between portions 16, 18 and gimbal 26 (see FIG. 3 at 20B) to prevent rotation beyond the design range of the mechanism. The ribbon cable management system 170 can be designed for attachment to either side of the articulated mechanisms, viz., the arm portions 16, 18 or the casing 1 and gimbal 26.

Display system 10 preferably utilizes a Kopin active-matrix liquid crystal display (AMLCD) CyberDisplay 320, shown at 200, available in either monochrome or color, manufactured and distributed by Kopin Corporation, 695 Myles Standish Boulevard, Taunton, Mass. 02780. The CyberDisplay 320, which uses a solid state LED as its light source, has 320×240 spatial resolution, and optionally uses a high efficiency backlight 210 designed to meet the low power and ruggedness requirements needed for portable applications. Backlight 210 snaps onto the rear of the display unit 200 to form the display and backlight assembly 180. The CyberDisplay 320 provides excellent eye relief allowing it to be positioned approximately three inches from the eye for comfortable viewing, has a rugged polycarbonate housing, and is of ultra-compact size having an active display area of only 4.8 mm×3.6 mm, or only 0.24 inches diagonally. Despite this small size, the virtual image seen by a user is comparable to viewing a 20-inch diagonal display from a distance of five feet. Kopin Corporation also manufactures an optical system suitable for use as focus mechanism assembly 40. Motorola Corporation also offers a solid state backlight suitable for use in preferred embodiments of the present invention. Clearly it is advantageous for a monocular viewing device to be adjustable for use by either the left or right eye. This can be accomplished by plugging an eyepiece into either a left or right receptacle, sliding a mechanism sideways along a track run, or pivoting a centrally mounted arm into a position suitable for viewing by either eye. Pivoting has been selected for the preferred embodiments because a pivoting mechanism is more durable and simpler to fabricate than a tracked mechanism, and does not entail problems due to disconnected, lost, damaged or contaminated piece-parts. However, embodiments of the cap-mounted monocular display system described herein could employ a tracked or modular mechanism or a variation of the pivoting mechanism described herein and still be adaptable to commonly available headgear and apparel.

FIG. 10 shows a block diagram for a wireless radio frequency video/audio receiver which is part of display system 10 and other preferred embodiments of the present invention. Such miniaturized receivers are quite common now and are commercially available from numerous manufacturers. RF video/audio transmitters and receivers such as the FIG. 10 receiver may be utilized legally in the UHF or VHF bands by licensed users, or in any of the unlicensed bands at 900 MHz, 2.4 GHz or 5.7 GHz. Other transmission modes such as infrared laser or acoustic waves also could be effectively used in specific applications. FIG. 10 further. includes a block diagram of electronics for the key components of the optics assembly 3 including the focus mechanism assembly 40, display unit 200, and backlight 180 available commercially from Kopin Corporation, and for a display signal decoder and LCD driver. Design of the circuitry and related components of the the RF and display systems will always be based upon current and rapidly emerging developments in RF transmission, power and display technologies, component miniaturization, integration, end user features and “price points” (ultimate product cost targets) and therefore will be reconfigured periodically on a continuing basis. The electronics section of the display system 10 is designed to receive wireless, radio frequency transmissions for video, audio and data from remote locations, or alternatively to interface directly with other types of devices which receive, store, process and/or deliver video/audio content. These techniques may be used separately or together to receive, process and distribute content for presentation by the display unit 200. Although FIG. 10 depicts a basic 2.4 GHz video/audio receiver and display-related circuitry, it should be noted that many different types of receiver systems can be employed to accommodate various needs and specific applications. Further, a complete radio-control transmitter system can optionally be added to the basic electronics package so that user(s) can operate remotely-controlled, video-guided vehicles and/or devices while they simultaneously monitor and respond to constantly changing images which are being captured and returned via wireless video/audio transmissions from the vehicles and/or devices. It is also possible to connect external video graphics generators, computers, cameras, night vision sensors, video or data storage devices, and other types of equipment to the display system 10 through an umbilical, to allow such equipment to use the display unit 200 or permit the use of external audio equipment. Display system 10 can be adapted to incorporate a solid state miniature video camera, integrated either as part of the casing 1 or optics assembly 3. Such miniature cameras and wireless transmitters and receivers are manufactured, distributed and retailed by companies such as: X-10, of Seattle, Wash.; Supercircuits of Liberty Hills, Tex.; and Marshall Industries of Torrance, Calif.

The FIG. 10 block diagram illustrates a preferred internal electronics configuration using a conventional 2.4 GHz video/audio receiver mounted on circuit board 150. This receiver, which is available from RadioShack Corporation, 100 Throckmorton Street, Ft. Worth, Tex. 76102, as its 2.4 GHz wireless observation kit (CW6601), is conventionally used for video-guided toys and remotely-directed video cameras. In the receiver portion of FIG. 10, video and audio are initially received at antenna 300 (shown in FIG. 7) which is manufactured using a process in which the essential receiving elements are designed or etched into or printed onto a flat substrate material which can then be mounted on or just above a printed circuit board (PCB). One such antenna type is known as a fractal antenna, or “fractenna,” because it uses numerous fractal triangles, etched into a surface, which ultimately become separate antennas in an antenna array. Such antennas through their jagged shapes generate electrical capacitance and inductance, thereby eliminating the need for external components to further tune the antenna or broaden the frequency range. Fractal antennas are produced by Fractal Antenna Systems Inc. of Malden, Mass., among others. The antenna 300 shown in FIG. 8, available as the “2.4 GHz Model” is specifically shaped for 2.4 GHz transmission and reception. This antenna consumes very little space and can be mounted flat within the primary casing 1 (see FIGS. 1 and 7). The antenna is relatively cheap, and cannot easily be broken, dirty or tangled during usage as would ultimately occur if a conventional antenna were used.

The blocks in FIG. 10 are more completely described as follows. Circuit board 150 includes: antenna 300; RF filter 302; low noise amplifier (LNA) 303; phase locked loop (PLL) 304; LNA 305; demodulator 306; signal 307; video out 308 (connected to an audio RCA connector 312A and a video RCA connector 312V); audio out 309 (connected to earpiece 112); and signal decoder and LCD driver 311 (connected to display unit 200 and backlight 210). Battery pack 350 is connected to circuit board 150 through switch 124. A camera module 400 includes: lens 401; camera sensor 402; iris control 403; microphone 404; audio amplifier 405; and a video/audio signal processor 406. Processor 406 inputs a video/audio signal 408 via video/audio selector switch 410 from a video/audio transmitter 360 (connected to antenna 360A), video/audio recording and storage device 380; or video/audio processor, special effects, enhanced vision processor or graphics generator 500.

In another preferred embodiment, the display system of the present invention is adapted to be a portable television. This is accomplished by adding a digital TV tuner. Such tuners are available from several manufacturers of digital tuners; one of these, the Japanese company Alps Electric Co., Ltd., 1-7 Yukigaya-Otsuka-cho, Otaku, Tokyo, Japan 145-8501, manufactures the preferred tuner for this application of the present invention. The Alps tuner is a chip tuner capable of tuning in VHF channels 1 to 13 and UHF channels 14 to 69. The Alps tuner, with its supporting circuitry is contained inside the primary display system case. This tuner and its supporting circuitry would be contained inside the primary casing.

While the present invention has been described in connection with what is presently considered to be the most practical and preferred embodiments, it is to be understood that the invention is not to be limited to the disclosed embodiments, but to the contrary, is intended to cover all modifications, equivalent arrangements and alternative constructions included within the spirit and scope of the invention, as set forth in the appended claims, and is to be accorded the broadest interpretation so as to encompass all such modifications, arrangements and constructions.

What is claimed is:

1. A monocular display system mounted to a headgear portion, comprising:
(a) a casing;
(b) a mounting device attached to the casing, detachably affixing the casing to and maintaining the casing aligned with and substantially parallel to the headgear portion;
(c) an arm attached to the casing and pivotable about a first axis generally orthogonal to the casing; and
(d) an optics assembly having an end attached to a housing containing a display assembly, the housing attached to the arm and pivotable about a second axis generally orthogonal to the casing and generally parallel to the first axis.

2. The display system of claim 1, wherein said headgear portion is selected from the group consisting of a cap visor and a hat brim.

3. The display system of claim 2, wherein said mounting device is a spring clip.

4. A monocular display system mounted to a headgear portion, comprising:
(a) a casing having an upper portion and a lower portion interfacing at a mating flange determining a reference plane;
(b) a mounting device attached to the casing upper portion, detachably affixing the casing to the headgear portion;
(c) an arm having first and second portions determining generally circular upper and lower mating flanges, the upper flange pivotally attached to the casing lower portion, the arm and flanges generally parallel to the reference plane, the arm pivotable at the upper flange about a first axis generally orthogonal to the reference plane; and
(d) an optics assembly having a focus mechanism assembly determined by first and second ends, the first end connected to an eyecup, the second end attached to a housing containing a display and backlight assembly, the housing attached to a gimbal attached to the lower flange and pivotable about a second axis generally orthogonal to the reference plane and generally parallel to the first axis.

5. The display system of claim 4, wherein said headgear portion is selected from the group consisting of a cap visor and a hat brim.

6. The display system of claim 5, wherein said mounting device is a spring clip.

7. The display system of claim 5, wherein pivotal movement of the arm about said first axis, pivotal movement of the optics assembly about said second axis, and gimbaled movement of said housing allows the eye cup to be positioned for the left or right eye when the headgear is worn by a user.

8. The display system of claim 5, wherein said display and backlight assembly comprises a video/audio display.

9. The display system of claim 5, wherein said casing contains a circuit board with circuitry for a wireless radio frequency video/audio receiver and a fractal antenna, and said optics assembly further comprises electronic circuitry.

10. The display system of claim 9, wherein said optics assembly circuitry is connected to said display and backlight assembly by a ribbon cable passed through said arm.

11. The display system of claim 9, further comprising a battery pack and an audio earpiece connected by an audio microphone and power cord to the circuit board.

12. A monocular display system mounted to a baseball-type cap visor, comprising:
(a) a primary casing having an upper portion and a lower portion interfacing at a mating flange determining a reference plane, the casing upper portion contoured so as to shape and support the underside of the cap visor, the casing lower portion having therethrough a generally circular hole;
(b) a spring mounting clip attached to the casing upper portion, detachably affixing the casing to the cap visor;
(c) an adjustment arm having first and second portions determining generally circular upper and lower mating flanges, the upper flange pivotally attached to the casing lower portion, the arm and flanges generally parallel to the reference plane, the arm pivotable at the upper flange about a first axis generally orthogonal to the reference plane; and
(d) an optics assembly having a focus mechanism assembly determined by first and second ends, the first end connected to an eyecup, the second end attached to a display housing containing a display and backlight assembly, the housing attached to a gimbal attached to the lower flange which is pivotable about a second axis generally orthogonal to the reference plane and generally parallel to the first axis.

13. The display system of claim 12, wherein:
said focus mechanism assembly comprises a manually adjustable focus ring disposed between first and second telescoping focus rings, and a lens retainer bezel, having first and second lens elements, connected to the eyecup;
the display housing is generally spherical and comprises upper and lower hemispheres, and is attached to the gimbal by spindles molded into the gimbal; and
the display and backlight assembly comprises a display unit having an active-matrix liquid crystal display (AMLCD) and an LED light source, and a backlight which snaps onto the display unit.

14. The display system of claim 13, wherein said primary casing contains a circuit board with circuitry for a wireless 2.4 GHz video/audio receiver and a fractal antenna, and said optics assembly further comprises a camera module comprising electronic circuitry.

15. The display system of claim 14, wherein said 2.4 GHz video/audio receiver circuitry comprises:
(a) a radio frequency filter;
(b) first and second low noise amplifiers;
(c) a phase locked loop;
(d) a demodulator; and
(e) a signal decoder and LCD driver

16. The display system of claim 14, wherein said camera module electronic circuitry comprises:
(a) a camera sensor;
(b) an iris control;
(c) a microphone;
(d) an audio amplifier; and
(e) a video/audio signal processor

17. The display system of claim 12, wherein said primary casing is fabricated from a polycarbonate plastic.
